(19) United States
(12) Patent Application Publication
(10) Pub. No.: US 2011/0067221 A1
(43) Pub. Date: Mar. 24, 2011

(54) DRAPERY ROD BRACKET

(75) Inventor: Brandon Seth Cross, Charlotte, NC (US)

(73) Assignee: NEWELL WINDOW FURNISHINGS,INC., High Point, NC (US)

(21) Appl. No.: 12/955,426

(22) Filed: Nov. 29, 2010

Related U.S. Application Data
(62) Division of application No. 12/504,258, filed on Jul. 16, 2009, now Pat. No. 7,861,989.
Application No. 12/504,258 is a continuation of application No. 11/550,083, filed on Oct. 17, 2006, now abandoned.

(51) Int. Cl. B23P 17/04

(52) U.S. Cl. 29/428

(57) ABSTRACT

The bracket comprises a support arm that can be mounted to either a vertical surface such as a wall or a horizontal surface such as a ceiling. A rod supporting member such as a ring or hook is removably attached to the arm and is adapted to receive and support a drapery rod. The rod supporting member can be removed from the support arm and attached directly to a surface to provide an inside mount for the rod. A separate mounting clip may be used to mount the rod supporting member to the surface. the mounting clip may be provided with a rod engaging element for centering the rod and a surface engaging element for fixing the position of the rod supporting member on the surface.

The invention relates generally to window coverings such as draperies and more particularly to an improved bracket for a drapery rod.

### BACKGROUND OF THE INVENTION

In a typical drapery rod installation the drapery rod consists of an elongated substantially cylindrical pole that is supported at or near its ends by brackets. Depending upon the type of drapery, the desired aesthetic look, the structure to which the rod is to be mounted, and other factors, different types of brackets are used to mount the rod in different installations. For example, the brackets may be mounted to a vertical surface such as a wall (wall mount), to a horizontal surface such as a ceiling (ceiling mount) or to the inside of a surface such as a window casement (inside mount) where each mounting arrangement requires a different type of bracket having a structure particularly suited for the type of installation.

The necessity of providing different mounting brackets can make the sale and installation of drapery rods unduly complicated and expensive. Manufacturers and retailers are required to stock different types of brackets and customers are required to purchase the type of bracket particularly suited for the type of installation. For do-it-yourself installations, the customer often is uncertain of the type of bracket that is required for the particular installation at the time of purchase leading to frustration and wasted time and effort. Moreover, drapery rods and brackets may be sold as kits where the rod and brackets are sold together complicating both the purchase decision of the customer and inventory and supply issues for the manufacturer and retailer.

Thus an improved drapery rod bracket is desired.

### SUMMARY OF THE INVENTION

The bracket of the invention comprises an adjustable support arm that can be mounted to either a vertical surface such as a wall or a horizontal surface such as a ceiling. A rod supporting member such as a ring or hook is removably attached to the arm and is adapted to receive and support the drapery rod. The rod supporting member can be removed from the support arm and attached directly to a surface to provide an inside mount for the rod. A separate mounting clip may be used to mount the rod supporting member to the surface. The mounting clip may be provided with a rod engaging element for centering the rod and a surface engaging element for fixing the position of the rod supporting member on the surface. A rod may be supported by the bracket in the wall mount, ceiling mount and/or inside mount positions.

### BRIEF DESCRIPTION OF THE DRAWINGS

FIG. 1 is a perspective view of the bracket of the invention.

FIG. 2 is a perspective view of the bracket of the invention with the components in a disassembled condition.

FIG. 3 is a perspective view of the rod supporting member and separate mounting clip in a disassembled condition.

FIG. 4 is a perspective view of the rod supporting member and separate mounting clip in an assembled condition.

FIG. 5 shows the bracket of the invention used as a wall mount.

FIG. 6 shows the bracket of the invention used as a ceiling mount.

FIG. 7 shows the bracket of the invention used as an inside mount.

FIG. 8 is a rear perspective view of the rod supporting member and mounting clip.

FIGS. 9 through 11 show alternate embodiments of the bracket of the invention.

### DETAILED DESCRIPTION OF EMBODIMENTS OF THE INVENTION

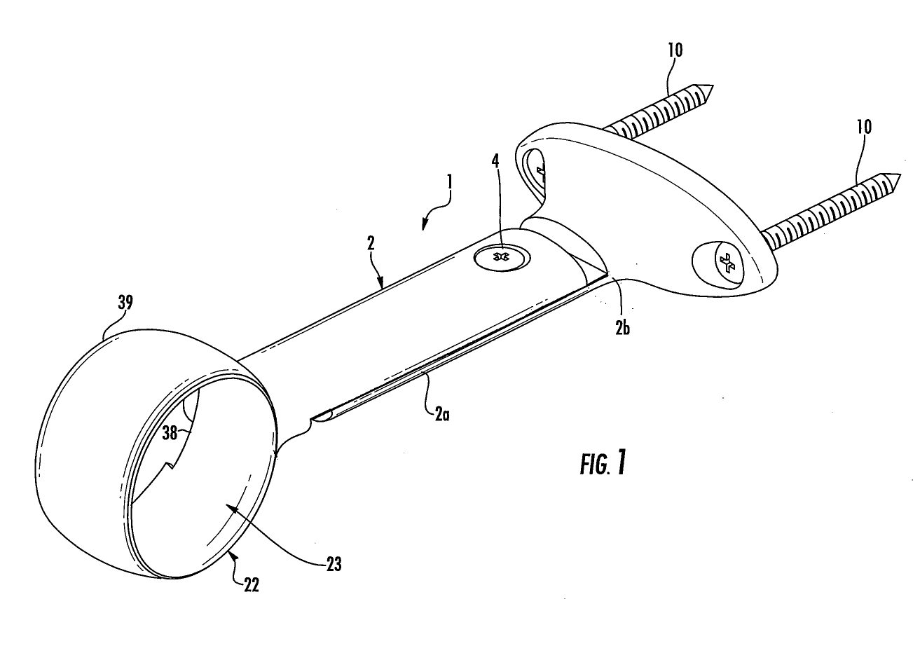

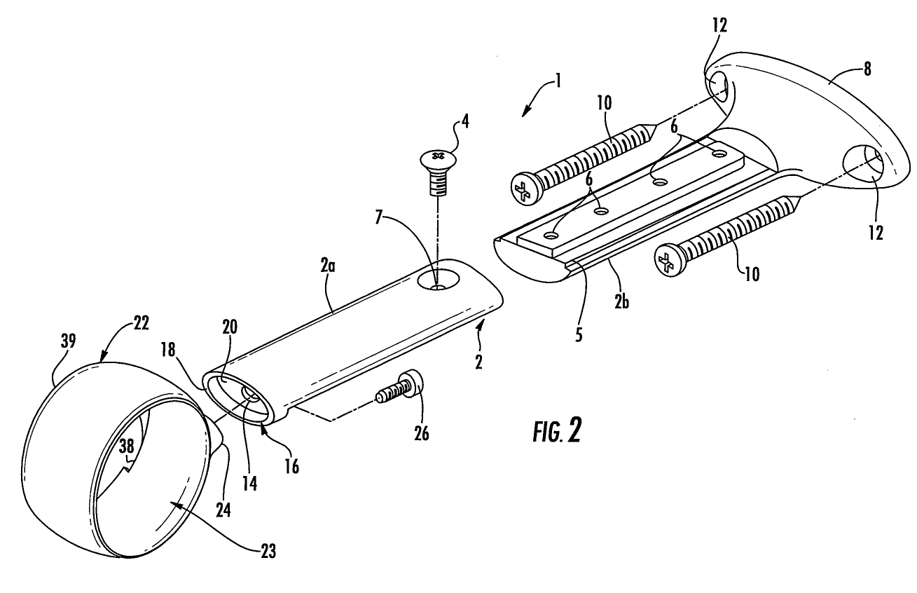

The bracket of the invention is shown generally at 1 in FIGS. 1 and 2 and comprises an adjustable support arm 2. Arm 2 has a first arm portion 2a and a second arm portion 2b where arm portion 2a can slide relative to arm portion 2b to adjust the length of the arm 2. Arm portion 2b is formed with a mounting flange 8 where flange 8 includes holes 12 for receiving screws or other fasteners 10. The fasteners 10 are inserted through the holes 12 and are secured to a surface such as a wall or ceiling to mount the arm to the surface. Mounting flange 8 may be made integrally with arm portion 2b or it may be a separate component attached thereto.

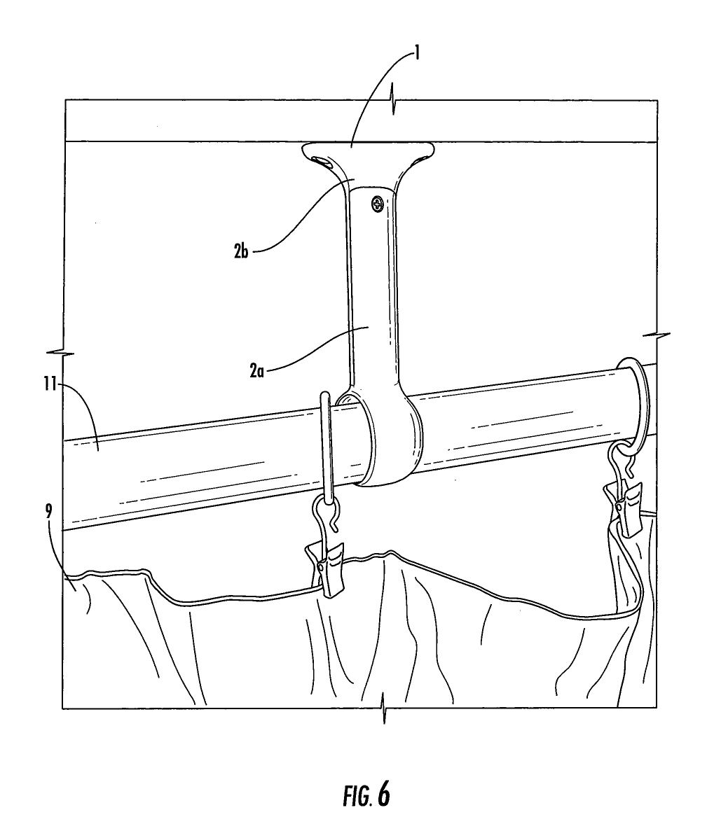

Arm portions 2a and 2b are formed with mating tracks 5 that allow the arms to reciprocate relative to one another in a telescoping manner to adjust the length of arm 2. Arm portion 2a is formed with a through hole 7 for receiving a fastener 4 such as a threaded screw. Arm portion 2b is formed with a plurality threaded holes 6 that can be selectively engaged by fastener 4 such that arm portion 2a can be fixed in position relative to arm portion 2b. The use of discrete threaded holes 6 rather than continuously adjustable members enables the bracket 1 to be used as a ceiling mount bracket as shown in FIG. 6. When a bracket is mounted to a ceiling or other horizontal surface the weight of the rod 11 and drapery 9 will tend to pull arm portion 2a from arm portion 2b. If continuously adjustable members are used to provide the adjustment where friction is relied on to fix the relative positions of the arm portions, the weight of the rod and drapery on the arm 2 may eventually cause the arm portions to slip relative one another and expand the bracket. Using the discrete adjustment where the fastener 4 mechanically engages one of the threaded holes 6, the position of the arm portions is fixed and the weight of the rod 11 and draperies 9 is supported.

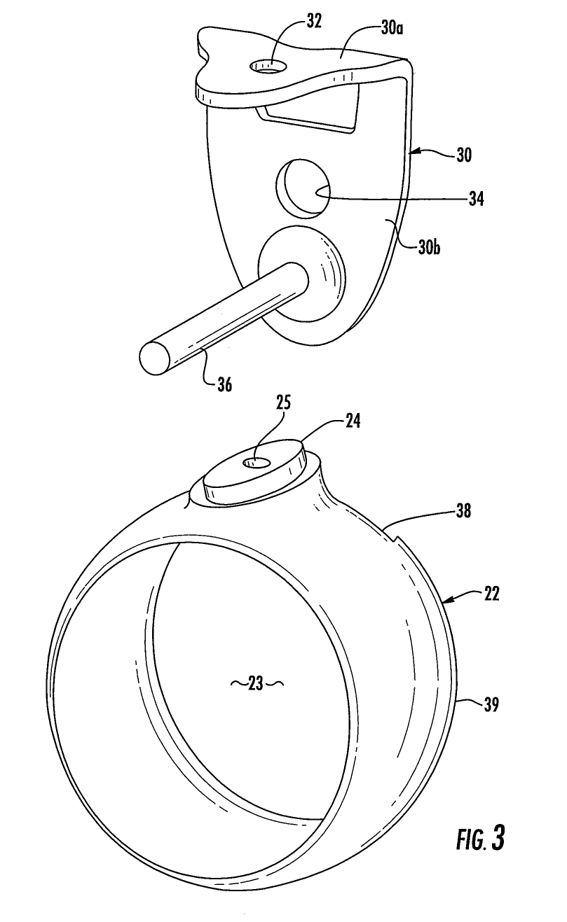

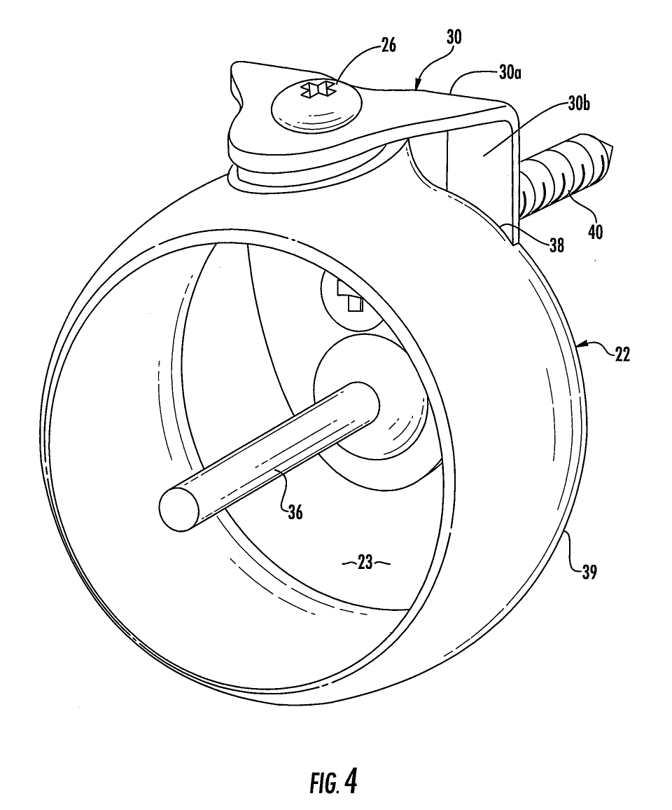

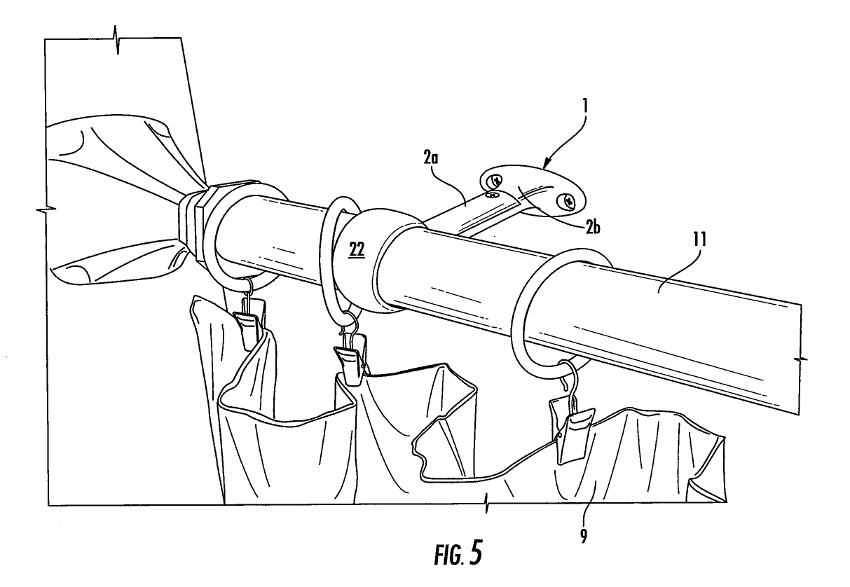

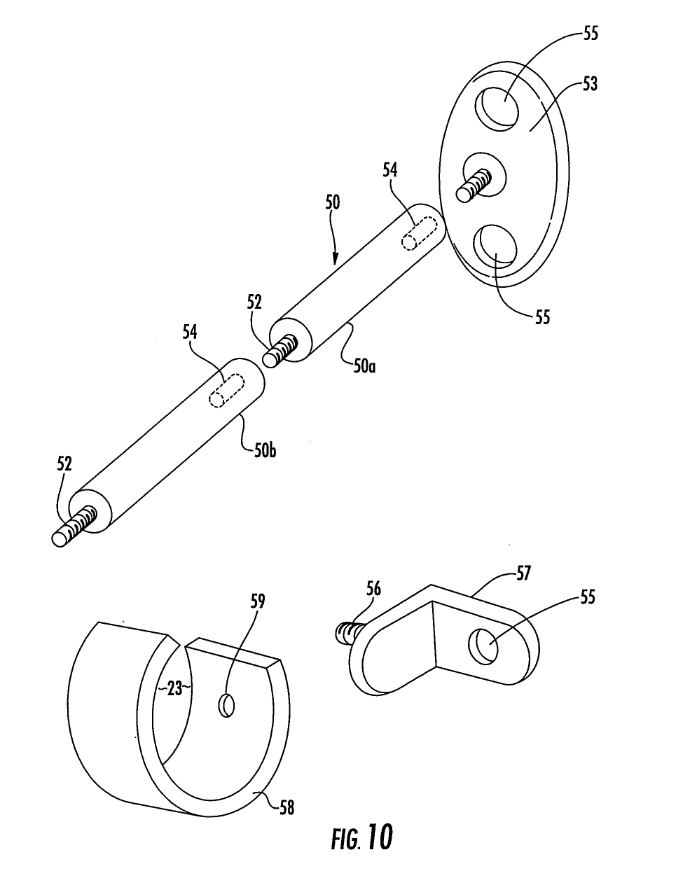

A hole 14 is formed in face 16 arranged at the end of arm portion 2a. In the illustrated embodiment surface 16 is bounded by a wall 18 to create a recessed area 20 that receives a mating protrusion 24 formed on rod supporting member 22. Rod supporting member 22 defines an interior space 23 in which the rod is located. In FIGS. 1 through 9 and 11 the rod supporting member 22 is a ring that surrounds the rod and in FIG. 10 the rod supporting member 58 is a hook that partially surrounds the rod. Other constructions of the rod supporting member are possible. Protrusion 24 has a threaded hole 25 (FIG. 3) that is arranged coaxially with hole 14. A threaded fastener 26 such as a screw is inserted through hole 14 and into threaded hole 25 to releasably secure the rod supporting member 22 to the arm 2. While a separate fastener is shown it is to be understood that either rod supporting member 22 or arm 2 may be provided with an integral fastener.

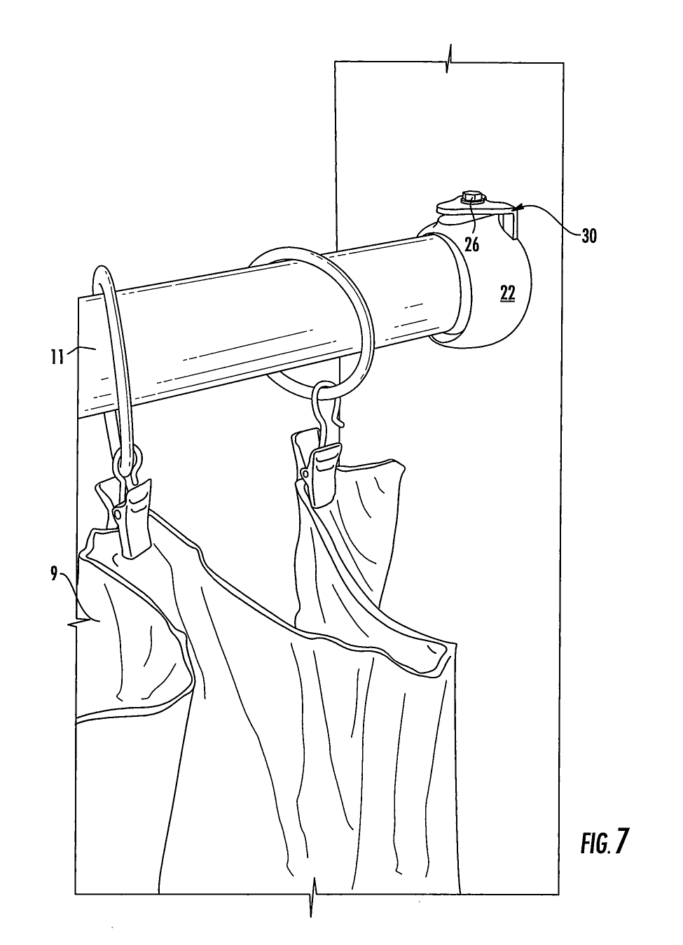

To mount the bracket as either a ceiling mount (FIG. 6) or a wall mount (FIG. 7), the assembly shown in FIGS. 1 and 2 is used. The arm 2 is secured to the surface using fasteners 10 in either a vertical orientation (ceiling mount) or a horizontal orientation (wall mount). Arm portion 2a can be adjusted relative to arm portion 2b to create an arm 2 of the desired length. The mechanical engagement of fastener 4 with discrete mating receptacles 6 fixes the arm portions 2a and 2b relative to one another in both a wall mount installation and a ceiling mount installation.

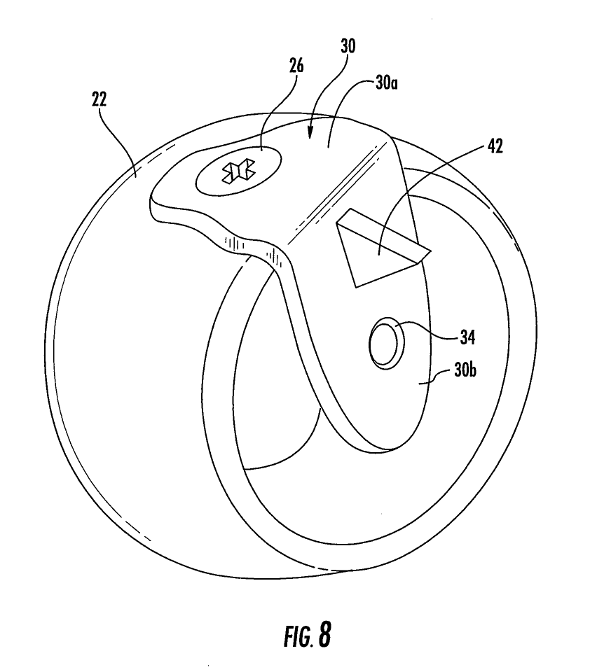

To use the bracket of the invention as an inside mount, the rod supporting member 22 is removed from arm 2 by unfastening fastener 26. Referring to FIGS. 3, 4 and 7 a mounting clip 30 is attached to rod supporting member 22 using fastener 26. In the embodiment illustrated in FIGS. 1 and 2, the fastener 26 is used to secure rod supporting member 22 to arm 2 and to secure mounting clip 30 to rod supporting member 22 although separate fasteners may be used. Moreover mounting clip 30 or rod supporting member 22 may be provided with an integral fastener. Mounting clip 30 includes a first flange 30a that extends substantially perpendicular to the surface to which it is mounted and has a first through hole 32 formed therein. A second flange 30b is arranged at approximately a right angle to flange 30a and includes a second through hole 34. The second flange 30b extends to the interior space 23 of the rod supporting member 22. A rod centering member such as post 36 may be provided on flange 30b that extends into rod supporting member 22. Post 36 extends into an aperture formed along the longitudinal axis of rod 11 to center the rod on the rod supporting member 22. Fastener 26 is inserted through hole 32 of mounting clip 30 and is threadably connected to threaded hole 25 on rod supporting member 22. Rod supporting member 22 is provided with a notch 38 along the edge 39 thereof that faces the surface to which member 22 is secured in the inside mount installation. Notch 38 is dimensioned to receive the mounting clip 30 such that the edge 39 of rod supporting member 22 is flush with the surface to which the member 22 is mounted. The notch 38 may be omitted if a flush mount of the rod supporting member 22 to the surface is not desired. A fastener 40 such as a threaded screw may be inserted through hole 34 to attach mounting clip 30 to a surface. As best shown in FIG. 8, a projection 42 may be provided on the surface of the flange 30b that faces the surface to which the rod supporting member 22 is mounted. Projection 42 may include a sharp point or edge that can be pressed into the surface to prevent the rod supporting member from rotating about fastener 40 when member 22 is secured to the surface.

Referring to FIG. 7, to mount a rod 11 to a ring-shaped rod supporting member 22 for an inside mount, the mounting clip 30 is secured to the surface at the desired location. The rod 11 is inserted into ring 22. The ring 22 is then secured to the mounting clip 30 using fastener 26. The opposite end of the rod is mounted in the same manner. If the rod supporting member comprises a hook such as shown in FIG. 10, mounting of the hook could be done as previously described. Alternatively, the hook-shaped rod supporting member 58 could be secured to the mounting clip first and both of these elements could than be mounted to the surface. The rod 11 could then be inserted into the hook 58 after the mounting clip 30 and hook 58 are mounted to the surface.

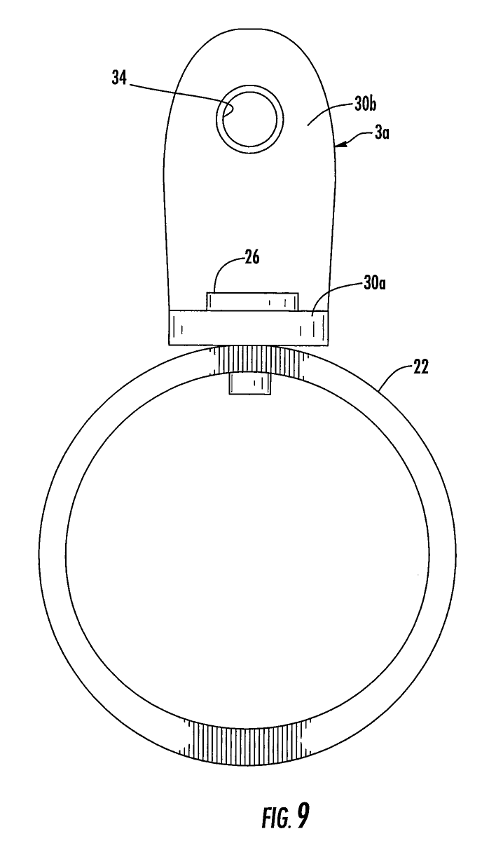

An alternate embodiment of the mounting clip 30 and rod supporting member 22 is shown in FIG. 9 where the mounting clip 30 is secured such that flange 30b is arranged extending outside of rod supporting member 22 rather than into the interior space of rod supporting member 22. Rod centering member 36 may be eliminated.

Another embodiment of the invention is shown in FIG. 10 where the arm 50 is comprised of discrete segments 50a and 50b that can be connected to one another and to wall mount flange 53 to vary the effective length of the arm. While the illustrated embodiment discloses two arm segments, a greater or fewer number of segments may be used. Each arm segment and the wall mount flange include a threaded male member 52 that engages a threaded hole 54 of the adjacent segment. The final segment can be threaded to rod supporting member 58. In such an arrangement, an additional threaded member 56 is used to connect the mounting clip 57 to threaded hole 59 of rod supporting member 58. Threaded member 56 may be integral with the mounting clip 57 as shown or it may be a separate fastener as described with respect to the embodiment of FIGS. 1 through 4. In the illustrated embodiment the rod supporting member 58 is a hook that extends for a portion of the periphery of rod 11 such that it can support the rod in both the ceiling mount and wall mount installations. Mounting clip 57 and mounting flange 53 are provided with through holes 55 for receiving fasteners (not shown) for mounting the bracket to a surface.

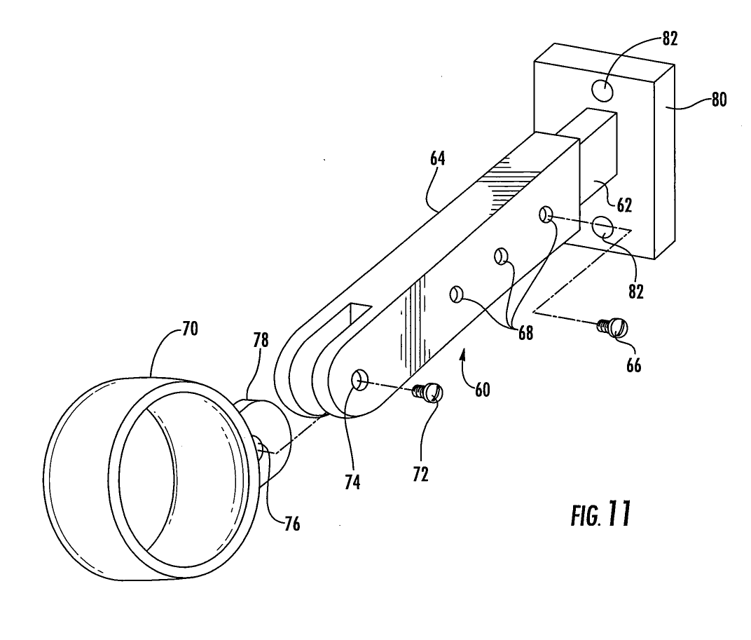

Another embodiment of the invention is shown in FIG. 11 where arm 60 includes a first segment 62 telescopically connected to a second segment 64. Segment 62 is connected to wall mount flange 80 that is provided with through holes 82 for receiving fasteners (not shown) for mounting the bracket to a surface. Segment 62 telescopically slides within a longitudinal channel formed in segment 64 and is maintained in position by a fastener 66 that is inserted through one of a plurality of aligned holes 68 and mechanically engages a threaded hole formed on member 62. The rod supporting member 70 is connected to arm 60 by a fastener 72 that is inserted through hole 74 formed on the arm 60 and mechanically engages threaded hole 76 formed on a flange 78 extending from the rod support element 70. For an inside mount, the rod supporting member 70 can be attached to the surface by a fastener engaging hole 76 such that a separate mounting clip need not be used.

While embodiments of the invention are disclosed herein, various changes and modifications can be made without departing from the spirit and scope of the invention. One of ordinary skill in the art will recognize that the invention has other applications in other environments. Many embodiments are possible. The following claims are in no way intended to limit the scope of the invention to the specific embodiments described above.

1.-20. (canceled)

21. A method of mounting a bracket in one of two types of installations comprising:
providing an arm for mounting to a surface including a rod supporting member,
said rod supporting member being removably secured to said arm;
mounting said arm to surface in a first type of installation;
removing said rod supporting member from said arm;
mounting the rod supporting member without said arm to a surface in a second type of installation.

22. An method for mounting a drapery rod comprising:
providing a drapery rod;
providing a rod supporting member for supporting the drapery rod in a substantially horizontal orientation;
providing an arm for mounting said drapery rod supporting member to a first surface having a first orientation relative to said rod, releasably connecting said arm to said rod, said arm including a first portion and a second portion adjustably fixed relative to said first portion such that when said first portion is fixed in a first position relative to said second portion said arm has a first length and when said first portion is fixed in a second position relative to said second portion said arm has a second length different than said first length;
providing a clip for mounting said drapery rod supporting member to a second surface having a second orientation relative to said rod, releasably connecting said clip to said rod supporting member;
selecting either said arm or said clip for mounting the drapery rod to the first surface or the second surface;
connecting the selected arm or clip to the rod supporting member;
attaching the selected arm or clip to the first or second surface; and
supporting said drapery rod on said rod supporting member.
